(19) United States
(12) Patent Application Publication
(10) Pub. No.: US 2026/0320649 A1
(43) Pub. Date: Oct. 15, 2026

(54) SYSTEM AND METHOD FOR AUTOMATICALLY ASSIGNING TARGETS BASED ON TARGET METRICS FOR A PLURALITY OF CAMPAIGNS

(71) Applicant: DATARIZE INC., Seoul (KR)

(72) Inventors: Seong Moo KIM, Seoul (KR); Gyu Min LEE, Seoul (KR); Min Sung PARK, Seoul (KR)

(21) Appl. No.: 19/691,507

(22) Filed: May 28, 2026

Related U.S. Application Data
(63) Continuation of application No. PCT/KR2023/021378, filed on Dec. 22, 2023.

(30) Foreign Application Priority Data
Dec. 7, 2023 (KR) 10-2023-0176633

(51) Int. Cl. G06Q 30/0251; G06Q 30/0242

(52) U.S. Cl. CPC G06Q 30/0251; G06Q 30/0246

(57) ABSTRACT

According to an embodiment of the present disclosure, a system for automatically assigning targets based on target metrics for a plurality of campaigns may include a memory configured to store information on a plurality of campaigns and information on a plurality of customers, a communication module configured to process transmission of at least one campaign among the plurality of campaigns to the plurality of customers, and a processor configured to identify customer targets for the plurality of campaigns, determine whether duplicate transmission is allowed for each of the plurality of campaigns, calculate a score for each customer target when at least one campaign is set as not allowing duplicate transmission, set a specific campaign among the plurality of campaigns for each customer target based on the calculated score, and transmit the specific campaign set to each customer target by using the communication module.

### CROSS-REFERENCE TO RELATED APPLICATION

This application is a U.S. Bypass Continuation application of International Application No. PCT/KR2023/021378, filed on Dec. 22, 2023, which claims priority to and the benefit of Korean Patent Application No. 10-2023-0176633, filed on Dec. 7, 2023, the disclosure of which is incorporated herein by reference in its entirety.

### BACKGROUND

### Technical Field

The present disclosure relates to a system and method for automatically assigning targets, and more particularly, to a system and method for automatically assigning targets based on target metrics for a plurality of campaigns.

### Background Art

Many companies operating commerce services send emails, text messages, KakaoTalk channel messages, app push notifications, and the like for CRM (customer relationship management) purposes in order to increase the purchase conversion rate and average order value of existing members. In order to send messages, it is necessary to configure a campaign based on the five Ws and one H.

For example, in order to send a message, it is necessary to set conditions for targeted recipients who will receive the message, and it is necessary to set a date and time at which the message will be sent. In addition, in order to send a message, it is necessary to set a channel through which the message will be sent (for example, email, text message, messenger (Alimtalk and Friendtalk (KakaoTalk channels)), app push notification, or the like), and it is necessary to set text, an image, a button name, a button link, and the like included in the message (creative). In addition, in order to send a message, a target metric indicating which quantitative metric is to be achieved by sending the message should be set, and other conditions, such as how many messages are allowed to be sent to one person per day, should be set.

Message performance may basically be evaluated through four metrics, i.e., visit rate, click-through rate, purchase conversion rate, and ROAS, after a campaign is created by setting all of the five Ws and one H and the message is sent. In order to further improve performance, a method called A/B testing is mainly used, in which approximately one of the five Ws and one H is changed and the message is sent, and, for example, the four metrics of Group A and Group B may be compared. Meanwhile, although such A/B testing is an excellent method for optimizing message performance, it is cumbersome in that a marketer must manually configure the settings each time, conduct the experiment, and perform subsequent analysis. In addition, if the number of message transmissions is not large, only a single variation may be tested in one experiment, and thus a long period of time may be required until optimization is achieved.

Accordingly, there is a need for a method capable of generating and transmitting a message optimized for each customer within a short period of time with only a simple setting.

In addition, there is a need for a method for distributing recipients such that only a specific campaign is sent when recipients of messages do not allow duplicate transmissions with respect to a plurality of campaigns.

### SUMMARY

### Technical Problem

An object of the present disclosure is to provide a system and method for automatically assigning targets based on target metrics for a plurality of campaigns, capable of automatically generating an optimized message with only a few simple settings by a marketer.

Another object of the present disclosure is to provide a system and method for automatically assigning targets based on target metrics for a plurality of campaigns, capable of transmitting only a specific campaign according to a preset rule when recipients of messages do not allow duplicate transmissions with respect to the plurality of campaigns.

### Technical Solution

According to an embodiment of the present disclosure, a system for automatically assigning targets based on target metrics for a plurality of campaigns may include a memory configured to store information on a plurality of campaigns and information on a plurality of customers, a communication module configured to process transmission of at least one campaign among the plurality of campaigns to the plurality of customers, and a processor. The processor may identify customer targets for each of the plurality of campaigns stored in the memory, determine, for each of the plurality of campaigns, whether duplicate transmission is allowed, calculate a score for each of the plurality of customer targets when, as a result of the determination, at least one campaign is set as not allowing duplicate transmission, set a specific campaign among the plurality of campaigns for each customer target based on the calculated score, and transmit the specific campaign set to each customer target by using the communication module.

The score may be calculated based on target metric settings calculable from data including a visit rate and a purchase conversion rate.

The processor may identify a transmission target channel for each of the plurality of customer targets and process transmission of the specific campaign through the identified transmission target channel.

The processor may select at least one transmission target channel based on relative performance among channels for the customer targets and relative performance among the campaigns.

The processor may allocate a minimum guaranteed number of targets for each of the plurality of campaigns and may set a specific campaign among the plurality of campaigns for each customer target based on the allocated minimum guaranteed number of targets.

The processor may set a maximum score for at least one new campaign among the plurality of campaigns and may set a specific campaign among the plurality of campaigns for each customer target based on the set maximum score.

When there are a plurality of new campaigns, the processor may process the plurality of customer targets to be equally distributed among the plurality of new campaigns.

The new campaign may correspond to a campaign having no transmission history during a predetermined period.

According to an embodiment of the present disclosure, a method for automatically assigning targets based on target metrics for a plurality of campaigns by a processor may include storing information on a plurality of campaigns and information on a plurality of customers, identifying customer targets for each of the plurality of campaigns stored in a memory, determining, for each of the plurality of campaigns, whether duplicate transmission is allowed, calculating a score for each of the plurality of customer targets when, as a result of the determination, at least one campaign is set as not allowing duplicate transmission, setting a specific campaign among the plurality of campaigns for each customer target based on the calculated score, and transmitting, by using a communication module, the specific campaign set to each customer target.

The score may be calculated based on target metric settings calculable from data including a visit rate and a purchase conversion rate.

The method may include identifying a transmission target channel for each of the plurality of customer targets and transmitting the specific campaign through the identified transmission target channel.

The method may include selecting at least one transmission target channel based on relative performance among channels for the customer targets and relative performance among the campaigns.

The method may include allocating a minimum guaranteed number of targets for each of the plurality of campaigns and setting a specific campaign among the plurality of campaigns for each customer target based on the allocated minimum guaranteed number of targets.

The method may include setting a maximum score for at least one new campaign among the plurality of campaigns and setting a specific campaign among the plurality of campaigns for each customer target based on the set maximum score.

The method may include, when there are a plurality of new campaigns, processing the plurality of customer targets to be equally distributed among the plurality of new campaigns.

### Advantageous Effects

According to the present disclosure, there is an advantage in that an optimized message can be automatically generated and transmitted with only a few simple settings by a marketer, without the need to experiment with, measure, determine, and adjust all of the elements corresponding to the above-described five Ws and one H.

According to the present disclosure, there is an advantage in that an optimized message can be automatically generated with only a few simple settings by a marketer. For example, there is an advantage in that, when a marketer inputs only simple settings, an item of interest may be estimated for each member, and creative content (for example, an image, text, or the like) may be automatically generated and transmitted.

In addition, according to the present disclosure, there is an advantage in that, when recipients of messages do not allow duplicate transmissions with respect to a plurality of campaigns, only a specific campaign may be transmitted according to a preset rule.

### BRIEF DESCRIPTION OF THE DRAWINGS

FIG. 1 is a block diagram illustrating a detailed configuration of a system for automatically generating an optimal message for each customer in a multi-campaign environment according to an embodiment of the present disclosure.

FIG. 2 is a block diagram illustrating a detailed configuration of a scenario processing module according to an embodiment of the present disclosure.

FIG. 3 is a block diagram illustrating a detailed configuration of a scenario selection module according to an embodiment of the present disclosure.

FIG. 4 is a flowchart illustrating a method for automatically generating an optimal message for each customer in a multi-campaign environment according to an embodiment of the present disclosure.

FIG. 5 is a block diagram illustrating a system for automatically generating an optimal message for each customer in a multi-campaign environment according to an embodiment of the present disclosure.

FIG. 6 is a diagram illustrating a concept of automatically assigning targets based on target metrics for a plurality of campaigns according to an embodiment of the present disclosure.

FIG. 7 is a diagram illustrating a concept of automatically assigning targets based on target metrics for a plurality of campaigns according to an embodiment of the present disclosure.

FIG. 8 is a flowchart illustrating a method for automatically assigning targets based on target metrics for a plurality of campaigns according to an embodiment of the present disclosure.

### DETAILED DESCRIPTION

Embodiments of the present disclosure will now be described in detail with reference to the accompanying drawings. However, the present disclosure is not limited or restricted to the embodiments.

Terms used herein are for describing the embodiments and are not intended to limit the present disclosure. As used herein, singular forms also include plural forms unless the context clearly indicates otherwise. As used herein, the terms “comprises” and/or “comprising” do not preclude the presence or addition of one or more other elements, steps, operations, and/or devices in addition to the stated elements, steps, operations, and/or devices.

As used herein, terms such as “embodiment,” “example,” “aspect,” and “illustration” are not to be construed as indicating that any described aspect or design is superior to or advantageous over other aspects or designs.

Further, the term “or” is intended to mean an inclusive or rather than an exclusive or. That is, unless otherwise stated or unless clear from the context, the expression “x uses a or b” means any one of the natural inclusive permutations.

Further, as used herein and in the claims, a singular expression (“a” or “an”) should generally be construed to mean “one or more” unless otherwise stated or unless it is clear from the context that the expression is directed to a singular form.

Further, as used herein and in the claims, terms such as “first” and “second” may be used to describe various elements, but the elements should not be limited by such terms. Such terms are used only for the purpose of distinguishing one element from another element.

Unless otherwise defined, all terms used herein, including technical and scientific terms, may be used with meanings commonly understood by a person having ordinary skill in the art to which the present disclosure pertains. In addition, terms defined in generally used dictionaries are not to be interpreted ideally or excessively unless they are clearly and specifically defined otherwise.

Meanwhile, in describing the present disclosure, when it is determined that a detailed description of a related known function or configuration may unnecessarily obscure the gist of the present disclosure, the detailed description thereof will be omitted. In addition, the terminology used herein is terminology used to properly describe embodiments of the present disclosure, and may vary depending on the intent of a user or operator or on custom in the field to which the present disclosure pertains. Accordingly, the definitions of such terms should be made based on the contents throughout this specification.

In various embodiments described below, a campaign may be a concept including an advertisement, but is not limited to specific advertisement data. According to an embodiment, campaign information may be referred to as scenario data, and the scenario data may include at least one of text, an image, a video, and an animation.

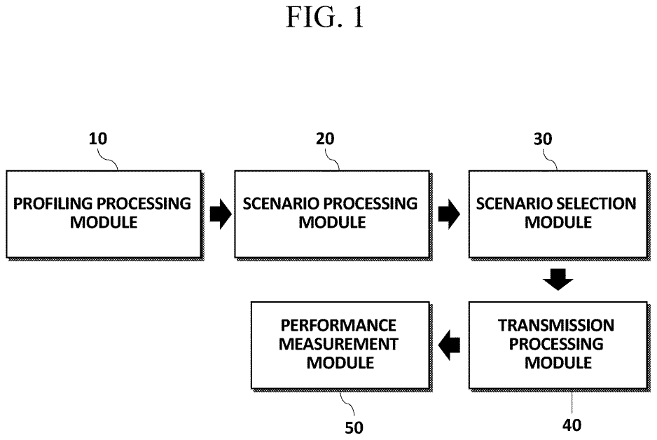

FIG. 1 is a block diagram illustrating a detailed configuration of a system for automatically generating an optimal message for each customer in a multi-campaign environment according to an embodiment of the present disclosure.

Referring to FIG. 1, the system for automatically generating an optimal message for each customer in a multi-campaign environment according to an embodiment of the present disclosure may include a profiling processing module 10, a scenario processing module 20, a scenario selection module 30, a transmission processing module 40, and a performance measurement module 50.

The profiling processing module 10 may generate profiling based on behavioral data on a browser and metadata of a customer company. For example, the behavioral data on the browser may include at least one of a page uniform resource locator (URL), an item exposure count, cart information, purchase information, and scroll information. The metadata of the customer company may include at least one of purchase history, member information, and promotion information. The profiling processing module 10 may calculate profiling based on information of the customer company itself (for example, metadata of the customer company) and behavioral information of each customer (for example, behavioral data on the browser). According to an embodiment, the profiling may include at least one of an interest level in a specific item, an interest level in a specific category, a purchase probability, and a revisit probability. The profiling may be calculated according to a known calculation method.

The profiling processing module 10 may generate profiling result data according to the profiling generation process. In this case, the profiling result data may include goal-oriented profiling data. For example, the goal-oriented profiling data may be generated by automatic tuning based on profiling parameters derived from a marketing action and performance thereof. The profiling result may be generated for each date and/or for each time. The profiling result may include individual profiling data, and may further include a target and information regarding a subsequent marketing action.

According to an embodiment, the scenario processing module 20 may generate a plurality of scenario data based on the profiling result data generated by the profiling processing module 10.

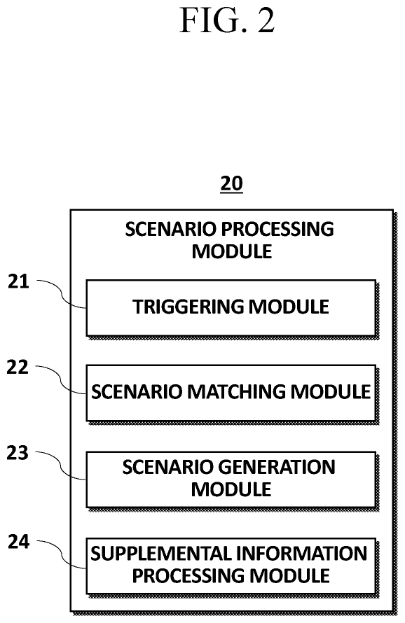

Hereinafter, the scenario processing module 20 will be described in detail with reference to FIG. 2.

FIG. 2 is a block diagram illustrating a detailed configuration of a scenario processing module according to an embodiment of the present disclosure.

Referring to FIG. 2, the scenario processing module 20 according to an embodiment may include a triggering module 21, a scenario matching module 22, a scenario generation module 23, and a supplemental information processing module 24.

According to an embodiment, the triggering module 21 may trigger simultaneous processing of batch data generation for scenario data and real-time requests for scenario data. To this end, the triggering module 21 may have a dualized architecture configured to simultaneously process the batch data generation operation and the real-time requests.

The scenario matching module 22 may select a target scenario based on a campaign execution status of a customer company, individual profiling, and performance data. For example, the campaign execution status of the customer company may include an activated marketing channel or a set time. The individual profiling and performance data may include data reflecting, for each campaign and for each period, a prior exposure status or an individual's intent (for example, turning off exposure).

The scenario generation module 23 may generate a plurality of scenario data for each individual. For example, because scenario data assigned to each individual may be selectively dropped later, the scenario generation module 23 may generate the plurality of scenario data.

The supplemental information processing module 24 may additionally generate supplemental information to be mandatorily included in a campaign. The supplemental information generated by the supplemental information processing module 24 may be attached to each of the plurality of scenario data generated by the scenario generation module 23.

Referring back to FIG. 1, according to an embodiment, the scenario selection module 30 may select final data for each individual from among the plurality of scenario data generated by the scenario processing module 20.

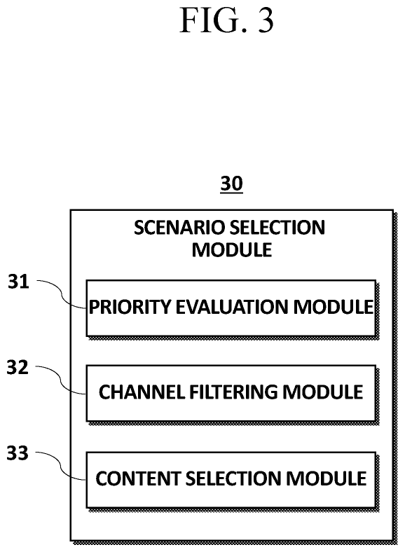

Hereinafter, the scenario selection module 30 will be described in detail with reference to FIG. 3.

FIG. 3 is a block diagram illustrating a detailed configuration of a scenario selection module according to an embodiment of the present disclosure.

Referring to FIG. 3, the scenario selection module 30 may include a priority evaluation module 31, a channel filtering module 32, and a content selection module 33.

According to an embodiment, the priority evaluation module 31 may sort a plurality of scenario data based on priority information derived from a customer company's past campaign performance. For example, the priority evaluation module 31 may select and configure a plurality of metrics, such as open rate, click-through rate, and ROAS (Return on Ad Spend), according to a campaign objective. The priority evaluation module 31 may further include response logic for a new campaign (cold start).

According to an embodiment, the channel filtering module 32 may remove unnecessary data by filtering, from among the plurality of scenario data, unnecessary data (for example, scenario data) according to settings/policies such as a channel status and cost control for each customer company. In this manner, by removing unnecessary data from among the plurality of scenario data, billing may be controlled, and overbilling and erroneous transmission may be blocked in advance.

According to an embodiment, the content selection module 33 may perform an operation of selecting content (for example, scenario data) to be actually exposed to a customer and generating final scenario data. The content selection module 33 may generate scenario data for each individual based on previously received campaign data for each customer. In this case, the content selection module 33 may apply a tracking means for measuring campaign performance.

Referring back to FIG. 1, according to an embodiment, the transmission processing module 40 may process transmission of final scenario data selected by the scenario selection module 30 for each individual and for each channel. For example, the transmission processing module 40 may process transmission of the final scenario data selected by the scenario selection module 30 by at least one means of banner, email, SMS, MMS, notification talk, channel talk, talk provided by a portal site, and app push. In this case, the transmission processing module 40 may transmit a personalized message (for example, scenario data) in real time or at a preset time. The transmission processing module 40 may determine channel status of a site by collecting indicators related to transmission itself, such as transmission success or exposure success.

According to an embodiment, the performance measurement module 50 may measure performance of a campaign. For example, the performance measurement module 50 may collect different feedback data according to characteristics of each channel. In this case, the performance measurement module 50 may collect direct response data of a recipient based on a user's open or click behavior. In addition, the performance measurement module 50 may link in-site behavioral data after the response of the recipient. In addition, the performance measurement module 50 may configure a feedback loop such that the performance measurement result is reflected back in profiling of the customer. Accordingly, the profiling processing module 10 described above may regenerate profiling of the customer based on the performance measurement result received as feedback from the performance measurement module 50.

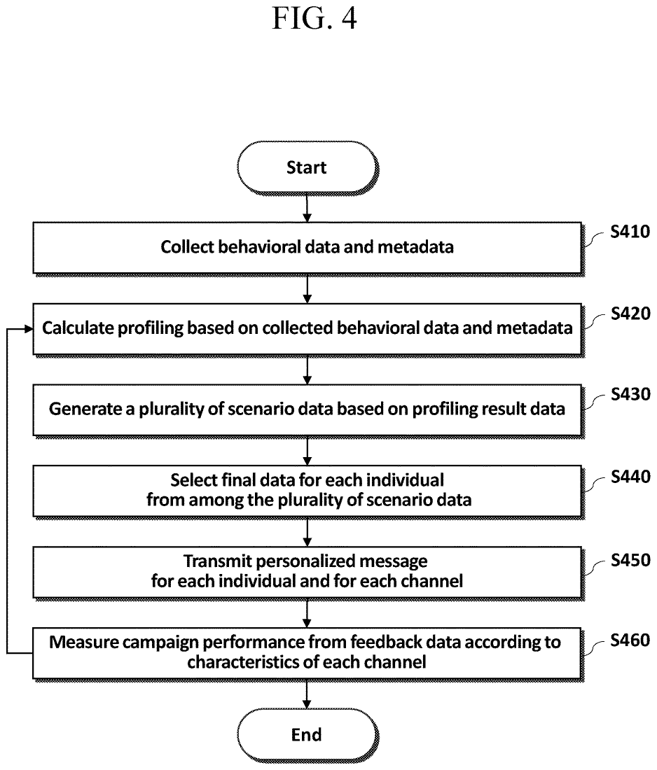

FIG. 4 is a flowchart illustrating a method for automatically generating an optimal message for each customer in a multi-campaign environment according to an embodiment of the present disclosure.

Referring to FIG. 4, according to an embodiment, the system for automatically generating an optimal message for each customer in a multi-campaign environment may first collect behavioral data on a browser and metadata of a customer company (S410). The system for automatically generating an optimal message for each customer in a multi-campaign environment may then perform a step of generating profiling based on the collected behavioral data and metadata (S420).

Next, the system for automatically generating an optimal message for each customer in a multi-campaign environment may generate a plurality of scenario data based on result data of the generated profiling (S430).

Next, the system for automatically generating an optimal message for each customer in a multi-campaign environment may select final data for each individual from among the plurality of scenario data (S440).

Next, the system for automatically generating an optimal message for each customer in a multi-campaign environment may transmit the selected final data for each individual and for each channel (S450).

Finally, the system for automatically generating an optimal message for each customer in a multi-campaign environment may measure campaign performance from feedback data according to characteristics of each channel (S460). In addition, the campaign performance measurement result may form a feedback loop such that the campaign performance measurement result is reflected back in profiling of the customer. Accordingly, profiling may be regenerated in step S420 based on the performance measurement result in step S460 received as feedback.

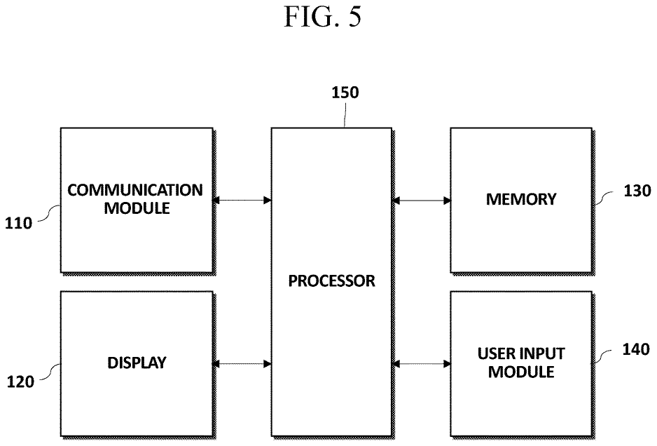

FIG. 5 is a block diagram illustrating a system for automatically generating an optimal message for each customer in a multi-campaign environment according to an embodiment of the present disclosure.

Referring to FIG. 5, the system for automatically generating an optimal message for each customer in a multi-campaign environment according to an embodiment may include a communication module 110, a display 120, a memory 130, a user input module 140, and a processor 150.

According to an embodiment, the communication module 110 may receive, from an external server, behavioral data on a browser and customer company metadata input to the profiling processing module 10. The behavioral data on the browser and the customer company metadata collected through the communication module 110 may be provided to the processor 150. The memory 130 may store the behavioral data on the browser and the customer company metadata collected through the communication module 110.

According to an embodiment, the processor 150 may process functions performed by the profiling processing module 10 based on the data collected through the communication module 110. For example, the processor 150 may perform functions of the respective modules shown in FIG. 1.

According to an embodiment, the processor 150 may transmit, through the communication module 110, final data (for example, scenario data) for each individual and for each channel.

According to an embodiment, the user input module 140 may receive a scenario triggering request (for example, a batch data generation request and/or a real-time request) from a user. The display 120 may display, on a screen, data input during a scenario data generation process or generated data. In addition, the display 120 may display, on the screen, a performance measurement result measured by the performance measurement module 50 after transmission of a personalized scenario message.

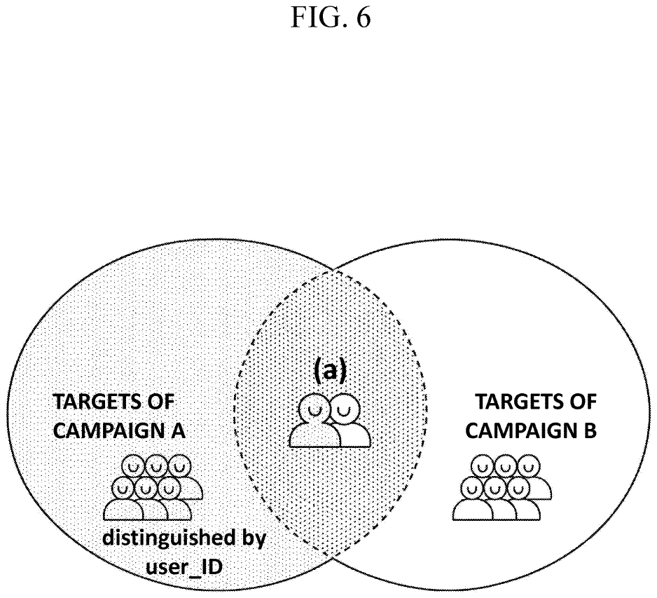

Hereinafter, a system and method for automatically assigning targets based on target metrics for a plurality of campaigns will be described with reference to FIGS. 6 to 8.

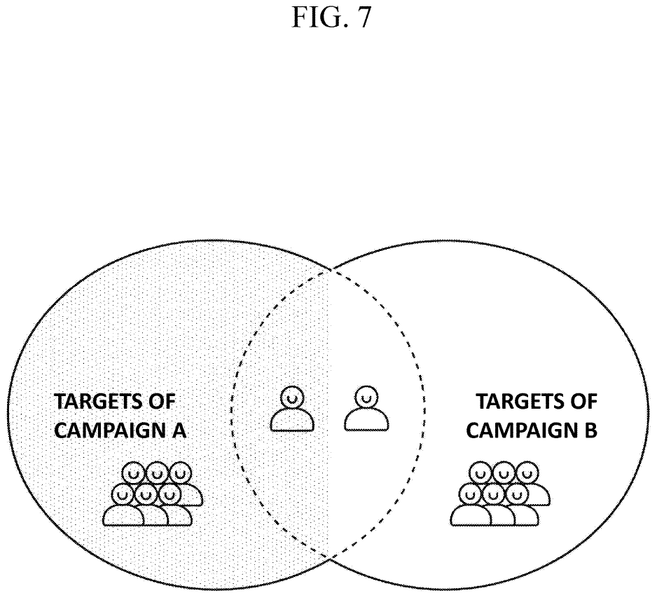

FIGS. 6 and 7 are diagrams illustrating a concept of automatically assigning targets based on target metrics for a plurality of campaigns according to an embodiment of the present disclosure.

Referring to FIG. 6, at least some of the targets of Campaign A and at least some of the targets of Campaign B may overlap. For example, targets corresponding to area (a) of FIG. 6 may be both targets of Campaign A and targets of Campaign B. In this case, Campaign A and Campaign B may be transmitted in an overlapping manner to the targets corresponding to area (a). In this case, the targets may be distinguished by user identification (ID).

Meanwhile, when there is no campaign, among Campaign A and Campaign B, that allows duplicate transmission, control should be performed such that only one campaign is transmitted per day according to a preset campaign selection rule.

Referring to FIG. 7, as described above, when there is no campaign that allows duplicate transmission, targets corresponding to (a) may be set as targets of Campaign A or targets of Campaign B according to a preset rule.

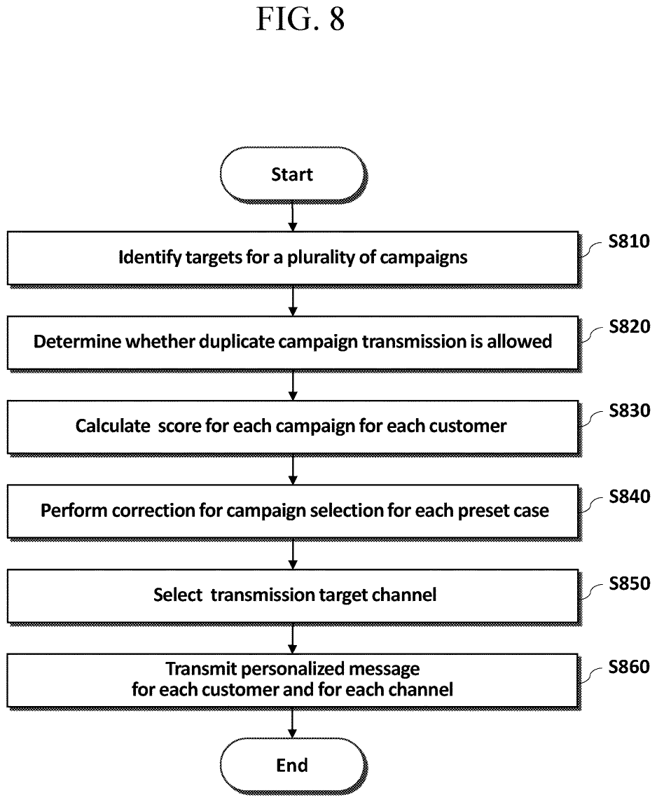

Hereinafter, a method for automatically assigning targets based on target metrics for the plurality of campaigns will be described in detail with reference to FIG. 8.

FIG. 8 is a flowchart illustrating a method for automatically assigning targets based on target metrics for a plurality of campaigns according to an embodiment of the present disclosure.

In the following description, although two campaigns are illustrated as examples of the plurality of campaigns for convenience of explanation, the same or a similar method may be applied to three or more campaigns. In addition, the methods described below may be performed by the above-described system for automatically generating an optimal message for each customer in a multi-campaign environment of FIG. 5. For example, each operation of the methods described below may be performed by the processor 150 of FIG. 5.

Referring to FIG. 8, first, the processor may identify targets for the plurality of campaigns (S810). For example, targets for Campaign A and targets for Campaign B may be identified. Meanwhile, as illustrated in FIG. 6, in the case of a specific target, the target may simultaneously correspond to a target of Campaign A and a target of Campaign B.

Next, the processor may determine whether duplicate campaign transmission is allowed (S820). For example, when Campaign A and Campaign B are set to allow duplicate transmission, Campaign A may be transmitted to targets of Campaign A, and Campaign B may be transmitted to targets of Campaign B. Accordingly, targets simultaneously corresponding to targets of Campaign A and targets of Campaign B may receive both Campaign A and Campaign B.

Meanwhile, when there is no campaign, among Campaign A and Campaign B, that is set to allow duplicate transmission, the campaigns should be distributed such that each target receives only one campaign. That is, because one customer is basically set to receive only one Friendtalk (KakaoTalk channels) message per day, customers in area (a) who become targets of multiple campaigns on the same day should be distributed such that they belong to only one campaign, as illustrated in FIG. 7.

According to an embodiment, the processor may calculate a score for each campaign for each customer (S830). According to an embodiment, the score may be calculated based on target metric settings calculable from data including a visit rate and a purchase conversion rate for each user. For example, the processor may calculate scores for Campaign A and Campaign B for each of a first user and a second user as shown in Table 1.

TABLE 1

| | Campaign A | Campaign B |
|---|---|---|
| First user | 0.3456789 | 0.01234567 |
| Second user | 0.0012345 | 0.01234567 |

For example, referring to Table 1, the first user and the second user may correspond to both Campaign A and Campaign B. In this case, because a score for Campaign A (0.3456789) is greater than a score for Campaign B (0.01234567), the first user may be assigned to Campaign A. Because a score for Campaign B (0.01234567) is greater than a score for Campaign A (0.0012345), the second user may be assigned to Campaign B. According to an embodiment, the processor may perform correction for campaign selection for each preset case after campaign selection for each user (S840). For example, when targets of Campaign A and targets of Campaign B are completely identical (for example, when they overlap 100%), the processor may perform correction such that all targets are not assigned to only one campaign. In addition, when either Campaign A or Campaign B is a new campaign, the processor may process all overlapped targets to be assigned to the new campaign. In this case, when the number of new campaigns is N, the overlapped targets may be equally assigned by dividing the overlapped targets by 1/N. The new campaign may be set as a campaign having no transmission history during the previous 30 days, but is not limited thereto.

According to an embodiment, the processor may select a transmission target channel for each user (S850). For example, when a plurality of channels are set for a specific user, the processor may select a specific channel according to a preset rule. In addition, when a specific channel for a specific user is in a disabled state, the processor may select an activated channel and transmit a campaign through the activated channel.

According to an embodiment, the processor may transmit a personalized message for each customer and for each channel according to the selected transmission target channel (S860).

According to an embodiment, when targets of two or more campaigns completely overlap, the number of targets of a low-performance campaign (that is, a campaign having a relatively low score) may become zero. For example, when sufficient existing data is available, a ratio of the numbers of targets may vary according to performance (for example, a score) among campaigns. In particular, when performance differs significantly, the number of targets of a specific low-performance campaign may become zero. In such a case, performance of the low-performance campaign may no longer be updated, and the low-performance campaign may be placed in an unrecoverable state. According to an embodiment, in such a case, by guaranteeing a minimum number of targets, it may be set such that all campaigns proceed with appropriate exploration within each execution interval. In this case, the minimum guaranteed number of targets may be allocated as a parameter that can have statistical significance within a set time interval. In this case, the minimum guaranteed number of targets should be set to be smaller than a parameter of a campaign having relatively superior performance.

Meanwhile, because a new campaign has no existing data (cold start problem), there may be no basis for competition among campaigns. Accordingly, in order to bring the competition into a converged state within a minimum period, the new campaign may be assigned the highest score and a maximum parameter. When a plurality of new campaigns (for example, n new campaigns) are generated at the same time, the same highest score may be assigned thereto, and targets may be set to be assigned at a frequency of 1/n.

According to an embodiment, the processor may adjust targets through competition among touchpoint channels. For example, when multiple direct touchpoint channels, such as email, text message, and app push, are available for one customer, sending one piece of content through all channels is highly likely to cause inconvenience to the customer. On the other hand, omnichannel marketing through multiple channels may result in high performance. Accordingly, because such a tendency may vary from customer to customer, the processor may calculate, for each customer, a boundary value for channel preference and communication frequency, and may select at least one transmission target channel (for example, 1 to n channels) based on relative performance among channels for each customer and relative performance among the campaigns.

The apparatus described above may be implemented using hardware components, software components, and/or a combination of hardware components and software components. For example, the apparatuses and components described in the embodiments may be implemented using one or more general-purpose computers or special-purpose computers, such as, for example, a processor, a controller, an ALU (arithmetic logic unit), a digital signal processor, a microcomputer, an FPA (field programmable array), a PLU (programmable logic unit), a microprocessor, or any other device capable of executing and responding to an instruction. A processing device may execute an operating system (OS) and one or more software applications executed on the operating system. In addition, the processing device may access, store, manipulate, process, and generate data in response to execution of the software. For convenience of understanding, although a single processing device may be described as being used, a person having ordinary skill in the art will appreciate that the processing device may include a plurality of processing elements and/or a plurality of types of processing elements. For example, the processing device may include a plurality of processors or a single processor and a single controller. In addition, other processing configurations, such as a parallel processor, are also possible.

Software may include a computer program, code, an instruction, or one or more combinations thereof, and may configure the processing device to operate as desired or may instruct the processing device independently or collectively. The software and/or data may be permanently or temporarily embodied in any type of machine, component, physical device, virtual equipment, computer storage medium or device, or transmitted signal wave, in order to be interpreted by the processing device or to provide instructions or data to the processing device. The software may be distributed over network-connected computer systems so as to be stored or executed in a distributed manner. The software and data may be stored in one or more computer-readable recording media.

A method according to an embodiment may be implemented in the form of program instructions executable by various computer means and recorded in a computer-readable medium. The computer-readable medium may include the program instructions, a data file, a data structure, or a combination thereof, alone or in combination. The program instructions recorded in the medium may be specially designed and configured for the embodiments, or may be known and available to those skilled in the art of computer software. Examples of the computer-readable recording medium include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of the program instructions include not only machine language code, such as that generated by a compiler, but also high-level language code executable by a computer using an interpreter or the like. The hardware devices described above may be configured to operate as one or more software modules in order to perform operations of the embodiments, and vice versa.

Although the embodiments have been described above with reference to limited embodiments and drawings, various modifications and changes may be made thereto by those skilled in the art based on the foregoing description. For example, appropriate results may be achieved even if the described techniques are performed in a sequence different from the described method, and/or components of the described system, structure, device, circuit, and the like are combined or arranged in a form different from the described method, or are replaced or substituted with other components or equivalents.

Therefore, other implementations, other embodiments, and equivalents to the appended claims are also within the scope of the following claims.

What is claimed is:

1. A system for automatically assigning targets based on target metrics for a plurality of campaigns, the system comprising:
a memory configured to store information on a plurality of campaigns and information on a plurality of customers;
a communication module configured to process transmission of at least one campaign among the plurality of campaigns to the plurality of customers; and
a processor,
wherein the processor is configured to:
identify customer targets for each of the plurality of campaigns stored in the memory;
determine, for each of the plurality of campaigns, whether duplicate transmission is allowed;
when, as a result of determining whether duplicate transmission is allowed, at least one campaign is set as not allowing duplicate transmission, calculate a score for each of the plurality of customer targets;
based on the calculated score, set a specific campaign among the plurality of campaigns for each customer target; and
transmit the specific campaign set to each customer target by using the communication module.

2. The system of claim 1, wherein the score is calculated based on target metric settings calculable from data including a visit rate and a purchase conversion rate.

3. The system of claim 1, wherein the processor is configured to:
identify a transmission target channel for each of the plurality of customer targets; and
process transmission of the specific campaign through the identified transmission target channel.

4. The system of claim 3, wherein the processor is configured to select at least one transmission target channel based on relative performance among channels for the customer targets and relative performance among the campaigns.

5. The system of claim 1, wherein the processor is configured to:
allocate a minimum guaranteed number of targets for each of the plurality of campaigns; and
based on the allocated minimum guaranteed number of targets, set a specific campaign among the plurality of campaigns for each customer target.

6. The system of claim 1, wherein the processor is configured to:
set a maximum score for at least one new campaign among the plurality of campaigns; and
based on the set maximum score, set a specific campaign among the plurality of campaigns for each customer target.

7. The system of claim 6, wherein, when there are a plurality of new campaigns, the processor is configured to process the plurality of customer targets to be equally distributed among the plurality of new campaigns.

8. The system of claim 7, wherein the new campaign corresponds to a campaign having no transmission history during a predetermined period.

9. A method for automatically assigning targets based on target metrics for a plurality of campaigns by a processor, the method comprising:
storing information on a plurality of campaigns and information on a plurality of customers;
identifying customer targets for each of the plurality of campaigns stored in a memory;
determining, for each of the plurality of campaigns, whether duplicate transmission is allowed;
when, as a result of determining whether duplicate transmission is allowed, at least one campaign is set as not allowing duplicate transmission, calculating a score for each of the plurality of customer targets;
based on the calculated score, setting a specific campaign among the plurality of campaigns for each customer target; and
transmitting, by using a communication module, the specific campaign set to each customer target.

10. The method of claim 9, wherein the score is calculated based on target metric settings calculable from data including a visit rate and a purchase conversion rate.

11. The method of claim 9, further comprising:
identifying a transmission target channel for each of the plurality of customer targets; and
transmitting the specific campaign through the identified transmission target channel.

12. The method of claim 11, further comprising selecting at least one transmission target channel based on relative performance among channels for the customer targets and relative performance among the campaigns.

13. The method of claim 9, further comprising:
allocating a minimum guaranteed number of targets for each of the plurality of campaigns; and
based on the allocated minimum guaranteed number of targets, setting a specific campaign among the plurality of campaigns for each customer target.

14. The method of claim 9, further comprising:
setting a maximum score for at least one new campaign among the plurality of campaigns; and
based on the set maximum score, setting a specific campaign among the plurality of campaigns for each customer target.

15. The method of claim 14, further comprising, when there are a plurality of new campaigns, processing the plurality of customer targets to be equally distributed among the plurality of new campaigns.
